(19) United States
(12) Patent Application Publication
(10) Pub. No.: US 2009/0287573 A1
(43) Pub. Date: Nov. 19, 2009

(54) SYSTEM AND METHOD FOR PROVIDING PAY-PER-CLICK SATELLITE ON A USER DESKTOP

(75) Inventors: Gregory MILLER, Coral Springs, FL (US); Michael R. Miller, Parkland, FL (US)

Correspondence Address: GREENBERG TRAURIG, LLP (DC/ORL), 2101 L Street, N.W., Suite 1000, Washington, DC, 20037, US

(73) Assignee: Fluent,Inc., Deerfield Beach, FL (US)

(21) Appl. No.: 12/337,476

(22) Filed: Dec. 17, 2008

Related U.S. Application Data
(60) Provisional application No. 61/014,341, filed on Dec. 17, 2007.

(51) Int. Cl. G06F 3/048; G06F 15/16; G06Q 30/00

(52) U.S. Cl. 705/14.55; 715/779; 709/202; 715/780; 705/14.73

(57) ABSTRACT

A system and method for placing a live, interactive, product specific communication conduit on user desktops. A retailer, wholesaler, or any other type of provider of goods or services having a website describing one or more products selects specific products for which the retailer desires to enable direct communication with consumers. The display of the selected products on the retailer's website are marked with an identifiable label, for example, the text “Grab-It”. Consumers are enabled to drag and drop the display of the product to their desktop, creating an interactive icon (also referred to herein as a “satellite icon”.) The interactive icon supports two-way messaging between the retailer and the consumer. The retailer is enabled to push content regarding the selected content, for example, product specific advertising to the icon for display. The consumer is enabled to request information or periodic updates regarding the product through the icon.

This application claims priority to U.S. Provisional Patent Application No. 61/014,341 filed on Dec. 17, 2007, which is incorporated by reference in its entirety herein.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of web based ecommerce and product information services, and in particular to web based product information services that place interactive content on user desktops.

### BACKGROUND OF THE INVENTION

From January through June 2006, total online spending by consumers totaled $80.8 billion, representing a 20.1 percent increase over the same period in 2005. Forecasts projected total e-commerce spending by consumers would reach approximately $170 Billion in 2006. “Despite the sluggishness of retail growth in general, online consumer spending remains strong,” noted Gian Fulgoni, Chairman and Co-Founder of comScore Networks. “Growth in non-travel online spending continues at a rate of 25 percent year-over-year, which suggests that consumers' online purchase behavior has been relatively unaffected by the general economic trends.”

The challenge every online retailer faces is how to best tap into this vast market. Retailers make use of a number of techniques to increase traffic on their site. Retailers typically aggressively market their sites to search engines, utilizing both unpaid search engine optimization techniques, as well as through use of pay-per-click services. Retailers may further pay to display banners or flash media advertisements on popular, high traffic web sites, possibly targeting content using cookie-based user profiles. Retailers may further occasionally send targeted emails to prior customers, or users on email lists collected over time.

A major disadvantage of such methods of advertising is that content is principally pushed to target consumers with limited input from the consumers regarding the consumer's specific interests or demographics. Another disadvantage to such methods of advertising is that such channels provide little or no opportunity for the consumer to interact directly with the retailer, for example, to ask detailed questions regarding specific products, such as if a specific product will be placed on sale in the near future. Yet another disadvantage of such methods of advertising is that the consumer may be forced to manually track the price and availability of a product of interest by, for example, frequently revisiting a retailer's web site.

It is therefore an object of the present invention to provide a system and method to enable retailers and consumers to establish a highly interactive, one-to-one relationship focused on products of interest to specific consumers.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the invention is a system and method for placing a live, interactive, product specific communication conduit on user desktops. A retailer, wholesaler, or any other type of provider of goods or services having a website describing one or more products selects specific products for which the retailer desires to enable direct communication with consumers. The display of the selected products on the retailer's website are marked with an identifiable label, for example, the text “Grab-It”. Consumers are enabled to drag and drop the display of the product to their desktop, creating an interactive icon (also referred to herein as a “satellite icon”.) The interactive icon supports two-way messaging between the retailer and the consumer. The retailer is enabled to push content regarding the selected content, for example, product specific advertising, whether solicited or unsolicited, to the icon for display. The consumer is enabled to request information or periodic updates regarding the product through the icon.

A first computer is enabled to modify an object visibly displayed on a webpage, wherein the modified object is thereby enabled to be to be used to create a satellite icon. A second computer having a display device is enabled to create a satellite icon visibly displayed on a desktop of a graphical user interface displayed on the display device by displaying the webpage on the display device, whereby the modified object is visibly displayed on the display device, and taking a first user interface action on the modified object. A communication channel is opened, over a network, between the second computer and a third computer when the satellite icon is created, whereby the third computer is enabled to send data to and receive data from the second computer.

In another embodiment, the invention is a system. The system comprises a first computer configured to modify an object visibly displayed on a webpage, wherein the modified object is thereby configured to be to be used to create a satellite icon, whereby a second computer having a display device is configured to create a satellite icon visibly displayed on a desktop of a graphical user interface displayed on the display device when, the webpage is displayed on the display device, whereby the modified object is visibly displayed on the display device, and a first user interface action is taken on the modified object. The system further comprises a third computer configured to communicate with the second computer using a communication channel opened, over a network, between the second computer and the third computer when the satellite icon is created, whereby the third computer is enabled to send data to and receive data from the second computer.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of the end-consumer interface for the invention.

FIG. 2 illustrates one embodiment of the overall system supporting the creation and use of satellite icons.

### DETAILED DESCRIPTION

Reference will now be made in detail to the preferred embodiments of the present invention, examples of which are illustrated in the accompanying drawings.

The present invention is described below with reference to illustrations of user interfaces and devices for web based product information services that place interactive content on user desktops. It is understood that the user interfaces described herein may be implemented using any commercially available GUI, such as, without limitation, that provided by Microsoft Windows or Apple Computers. It is further understood that illustrations of devices and user interfaces may be implemented by means of analog or digital hardware and computer program instructions.

These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

The following disclosure uses the term “retailer” or “merchant” to refer generally to persons or entities that offer products or services to third parties. The term is not intended to be used in the restrictive sense of an entity whose business is limited to retail sale of hard goods to end consumers, but may also embrace, for example, wholesalers whose customers are retailers, service providers whose customers purchases services, rather than hard goods, such as spa services, or entities whose principle product is information, such as news agencies. It should also be understood that where reference is made to a retailer's website, the website may represent an online store, where purchases may be made directly, or may represent a vehicle for advertising goods sold in a brick-and-mortar store.

The following disclosure further uses the term “consumer” to refer generally to persons or entities that seek to purchase products or services from third parties. The term is not intended to be used in the restrictive sense of a natural person seeking to purchase hard goods from a retailer, but may also embrace, for example, a retailer seeking goods from a wholesaler, a customer or of a spa service seeking to purchase spa services, or a person or entity seeking information from an information provider, such as a news agencies. The terms “retailer”, “merchant”, and “consumer” are used herein, not to restrict the invention as such, but rather, as simple intuitive terms which are well suited to describing the embodiments of the invention disclosed herein.

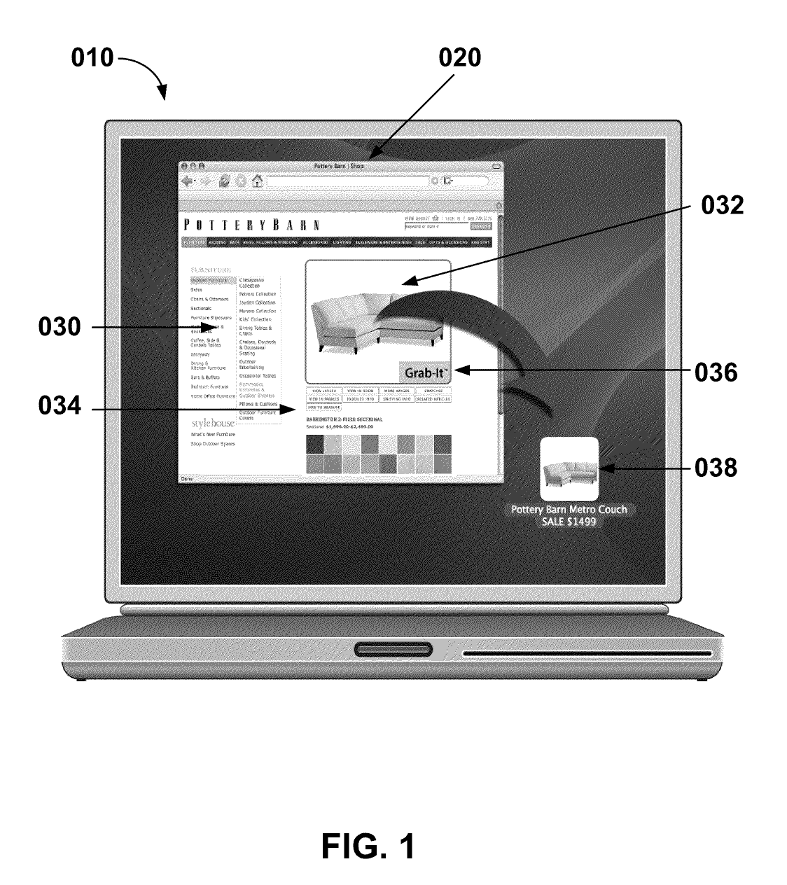

The present system and method enables a system and method to enable retailers and consumers to establish a highly interactive, one-to-one relationship focused on products of interest to specific consumers. FIG. 1 illustrates one embodiment of the end-consumer interface for the system. A web browser 020 displayed on the monitor 010 of a consumer's PC displays a retailer's web site 030. The specific page displayed on the browser is a page from the retailer's web site displays a picture 032 of a product offered for sale by the retailer, along with miscellaneous other product details 034. The consumer may have reached the specific page displayed on the browser 020 by any of the convention methods used by consumers to locate a product on the Internet, for example, by entering in a keyword search on a general purpose search engine and clicking on a search result, by directly entering the retailer's URL into the browser and patching through the web site's menu system, or by receiving a direct link to the web page in an email.

The picture 032 of the product offered for sale by the retailer contains an icon or label 036 in the lower right corner of the picture containing the text “Grab-It”. The text “Grab-It” notifies the consumer that the retailer offers interactive, product specific information regarding the displayed product, as described in further detail below. The illustrative text displayed in the label 036 is “Grab-It”, but the text may be any memorable word or short phrase, or, alternatively, may be a symbol. The label 036 itself may be located anywhere on the displayed web page 030 so long as the label is easily recognized, and it is clear what product to which the label refers. Positioning the label anywhere on the product's picture, as in the example in FIG. 1, is one effective alternative where the web page contains a relatively large image of the product. In the case of a web page listing a number of products with thumbnail images of individual products, it may be more effective to place the label in descriptive text next to the image.

In one embodiment, the consumer opens up a conduit for interactive information relating to the displayed product by clicking on the label 036 and dragging it to the desktop. The act of dragging the label 036 to the desktop causes the creation of a specialized icon 038 hereinafter referred to as a “satellite icon”, on the consumer's desktop. The satellite icon may be, e.g., any widget, gadget, snippet, text, image or video. Alternatively, or additionally, the act of dragging the product's picture to the desktop or double-clicking the label 036 may also be mechanisms which trigger the creation of a satellite icon 038 on the consumer's desktop.

The satellite icon then becomes the point of communication between the consumer and the retailer. For example, the icon can be used by the consumer to monitor the price of an item in which the consumer is interested, and may be utilized by the retailer to push information such as sales or promotion information about the item to the consumer, as will be described more fully below.

The satellite icon becomes the consumer's window into the retailer's world, and enables the retailer to share myriad types of information regarding the selected product with the consumer. In one embodiment, the satellite icon 038 may be configured, as in FIG. 1, to display a picture of the product the icon is tracking, so that the consumer will be able to immediately recognize what product the icon refers to. The retailer may choose to push product specific information to the satellite icon, such as, for example, current pricing, future sales events, special offers, enhancements to product design and the like. The product specific information could be displayed, for example, as text immediately below the icon as shown in 038 of FIG. 1. Alternatively, the icon could display the text within the icon, or the icon could display the pushed text in a separate window when clicked or when the cursor rolls over the icon.

The satellite icon may also be implemented to function as instant message vehicle for the consumer to ask questions directly to the specific item the icon refers to, such as, “When will you be going on sale?”, or “Do you come in green?”. The message may then be delivered in real time to the originator of the icon who can respond directly to the consumer's icon. The instant messaging functions of the satellite icon may be implemented, for example, such that a consumer can click on the icon and type in a freeform text question, or additionally or alternatively, selecting a predefined question from a dropdown or right-click enabled menu.

The satellite icon behaves similar to any other PC object—it is represented as an icon, can be stored and moved in folders, and can be opened to display detailed information that is continually updated and customized by the retailer. This enables consumers to maintain complete control of the relationships represented by the satellite icons. They can keep or discard the object, and thus the relationship. They also retain complete privacy control, and do not have to disclose personal information when creating the icon.

The functions associated with satellite icons may be further enhanced by linking the satellite icons to third party web services which contain demographic and other types of information about consumers. In one embodiment, a special linking folder for satellite icons and icons referring to third party web services may be created on the user's desktop. The linking folder may be created when a consumer enrolls in a satellite icon linking service, or may be created on demand. In one embodiment, the third party web services are social networking websites, although any subscriber-based web service wherein subscriber profile information or other types of subscriber information is retained could be used. Satellite icons in the linking folder are able to extract information about the consumer from the third party websites for which icons exist in the linking folder.

For example, a consumer who is enrolled in the linking service may assign their social networking websites, for example, myspace or facebook, to the linking folder. In one embodiment, when the consumer drops a satellite icons into a linking folder containing a social networking website, program code associated with the satellite icon automatically creates a social webpage that can plug-in to the social networking website, behaving, for example, like a sub-page. Depending on agreements with social networking sites, such sub-page could appear as another tab in each user's social networking site. Such sub-pages may be further customizable to be labeled as “Things I Want”, “Things I like,” etc.

Information regarding the consumer, for example, demographic information, may then be extracted from the social networking website and provided to the merchant sponsoring the satellite icon. Furthermore, merchants sponsoring the satellite icon may also receive information regarding other satellite icons in the linking folder. For example, the merchant may obtain a list of all products or brands existing in the linking folder.

Such a linking service provides significant benefits to merchants and consumers. For example, it completes the circle of information. When a consumer creates a linking folder and populates it with satellite icons relating to items the consumer is interested in, a complete picture of the consumer may be formed. A great deal of market data can be gathered and promotional and advertising premium opportunities may be identified. For example, if a consumer likes Gap Jackets, then Nordstrom may want to pay a premium to run ads adjacent to those satellites.

Furthermore, for the consumer, such linking capabilities may become a catalyst to leverage the social networking phenomenon as a marketing platform to drive use of satellite icons. The social networking phenomenon is driven by, at least in part, people's desire to share things about their life with friends and family. Consumers may wish to show their friends “Their Store”, their own personal desires—because they may want to share them as wish lists, or they may just want to “spread the word” about what the products and services they value. Thus, satellite icons may become strong viral marketing instruments with the potential to enhance the status of consumer items.

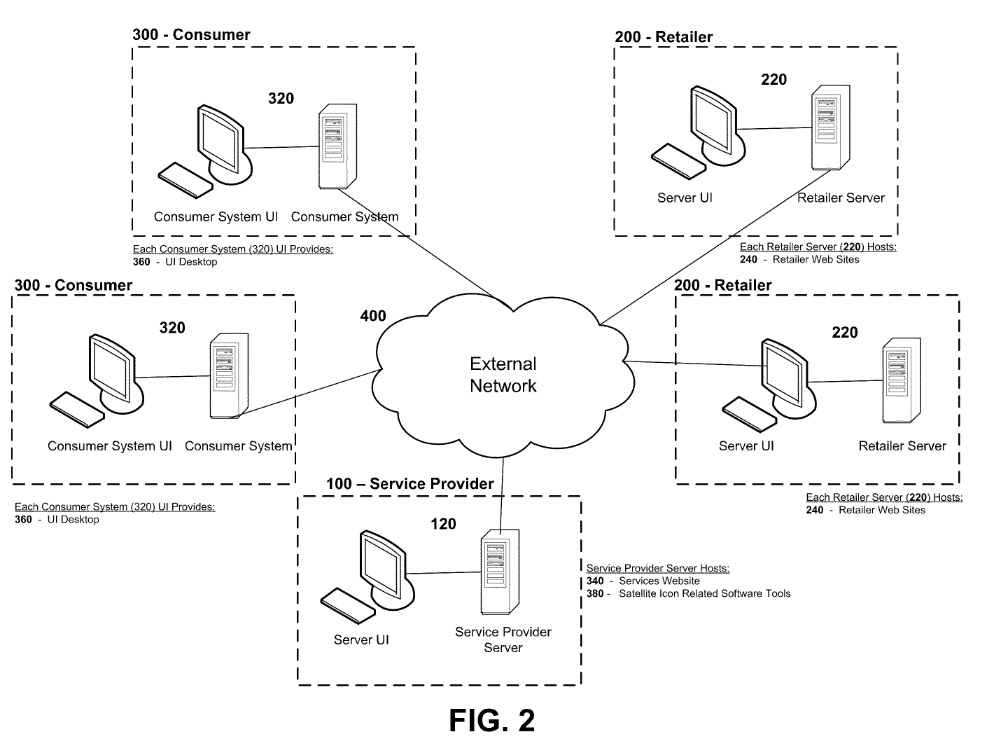

FIG. 2 illustrates one embodiment of an overall system supporting the creation and use of satellite icons as described above. There is a service provider 100 hosting a services website 140 on the service provider's server 120. The website, without limitation, allows retailers to enroll in a service which supports the creation and use of satellite icons. Retailers 200 host web one or more websites 240 on the retailer's server 220, such server being administered by the retailer, or, alternatively, may be provided by a third party web hosting service provider. The retailer's website 240 it created or maintained by or on behalf of the retailer and is designed to advertise and, optionally, sell, one or more of the retailer's products.

Retailers are able to access the services website 140 through an external network 400 for example, the Internet. The retailers are able to log onto the services website 120 and enroll in one or more service plans relating to satellite icons. Once enrolled in a satellite icon service plan the retailer 200 may then enable specific products displayed on their websites 240 for satellite icon support using tools provided on the services website. In the embodiment of the system illustrated in FIG. 1, a selected product then displays the “Grab-It” label 036. If the retailer has not enabled satellite icon support for a product, the label 036 will not appear, and the product does not support satellite icons.

Referring back to FIG. 2, consumers 300 interested in products offered by specific retailers 200 access the retailer's website 240 using the consumer's computer system 320 through the external network 400 to obtain product information. If a consumer 300 observes an indication on a specific product that the product supports satellite icons, for example, if the product exhibits a “Grab-It” label, the consumer may choose to create a satellite icon for that product by, for example, dragging and dropping the “Grab-It” label to his or her desktop 360. Alternatively, the software may provide the ability to drag the label or icon to a sidebar, peripheral display, or peripheral handheld device that is part of the computer system 320. The act of creating the satellite icon creates a communication channel between the consumer's computer system 320 and the service provider's server 120.

The retailer 300 may then communicate with the consumer via a dashboard interface. Such interface may be hosted by the service provider as a web-based application on the service provider server and accessed by the retailer remotely. Additionally, or alternatively, the dashboard could reside on the retailer's computer and some or all of the communication between the retailer 200 and the consumer 300 could occur through a peer-to-peer channel established between the retailer and the consumer when the satellite icon is created. The dashboard may allow the retailer to identify specific consumers or groups of consumers with which the retailer wishes to communicate. For example, it may allow the retailer to select all consumers who have clicked upon a particular satellite icon within the past two days and push information to such consumers regarding a sale of an item represented by the satellite icon.

In one embodiment, the retailer pays a “click cost” when the product is saved by the end consumers. The retailer further pays a “click cost” whenever the enabled product is clicked from a consumer's desktop. The services website 140 may further provide back-end software tools measure the distributed population of each representative item and enable the business to engage their customers via customized, one-to-one communications to each individual or groups of satellite icons (i.e. promotional messaging). Such communication could be handled by live customer representatives, and additionally, or alternatively, by automated systems that periodically push advertising information to satellite icons, or by rule based systems that automatically respond to simple, predefined questions.

In one embodiment, software tools provided by the services website 140 may be implemented such that the tools are entirely browser based and the tools are maintained locally on the service provider's server 120 or, alternatively, may be implemented as downloadable software which is downloaded by retailers 300 to their servers 320 and which communicates directly with satellite icon services provided by the service provider. Alternatively, or additionally, the service provider 100 could create and make available a general purpose API which would enable retailers, as well as third party developers, to develop applications which manage communications with satellite icons.

In one embodiment, technology supporting linking folders may be provided at the server level. When a consumer places an item in his or her linking folder, it could send a message to the server to populate that consumer's web-page with those items. Depending on which third party websites, for example, social networking websites, were selected by the consumer to participate in the linking service, the consumer may provide the linking service the consumer's username and passwords, which may be stored on the consumer's computer, or on the server.

While the invention has been particularly shown and described with reference to a preferred embodiment thereof, it will be understood by those skilled in the art that various changes in form and details may be made therein without departing from the spirit and scope of the invention. For example, the teachings herein may be applied to any icon or widget on the desktop, including those representing media files such as music files, image files, and movie files.

Furthermore, the use of satellite icons may be extended to other forms of advertising or media. For example, a merchant may associate a television commercial with a satellite icon. In one embodiment, a consumer who is views a television commercial associated with a satellite icon may access a mobile phone service supporting satellite icons and select the product for later download to the consumer's desktop. For example, the satellite icon application may allow a consumer to select a channel and grab satellites icons for the last 5 or 10 commercials. Radio ads may be similarly associated with satellite icons.

In yet another example, if a consumer hears a song outside of their home, for example, at a gym, a mobile phone application may be provided that displays the name of the song and asks the consumer if he or she would like to sample the song at a later date. The phone may capture the file for the consumer to sample, for example, on iTunes.

We claim:

1. A method comprising:
enabling a first computer to modify an object visibly displayed on a webpage, wherein the modified object is thereby enabled to be to be used to create a satellite icon,
enabling a second computer having a display device to create a satellite icon visibly displayed on a desktop of a graphical user interface displayed on the display device when,
the webpage is displayed on the display device, whereby the modified object is visibly displayed on the display device, and
a first user interface action is taken on the modified object visibly displayed on the display device;
causing a communication channel to be opened, over a network, between the second computer and a third computer when the satellite icon is created, whereby the third computer is enabled to send data to and receive data from the second computer.

2. The method of claim 1 additionally comprising the steps of:
enabling the second computer to display, using the satellite icon visibly displayed on the desktop of the graphical user interface, a representation of data relating to the modified object transmitted by the third computer to the second computer using the communication channel.

3. The method of claim 1 additionally comprising the steps of:
enabling the second computer to transmit from the second computer to the third computer, using the communication channel, data relating to at least a second user interface action taken on the satellite icon.

4. The method of claim 3 additionally comprising the steps of:
transmitting, over the network, data which is responsive to the at least a second user interface action from the third computer to the second computer.

5. The method of claim 1 wherein first user interface action is selected from the list:
select, single click, double click, mouseover.

6. The method of claim 1 wherein the at least a second first user interface action is selected from the list: select, single click, double click, mouseover, selection of a menu choice from a menu provided by the satellite icon, and typing text into a text entry field provided by the satellite icon.

7. The method of claim 2 wherein the object relates to a product and the data the transmitted by the third computer to the second computer using the communication channel relates to an advertisement for the product, whereby an advertisement for product is displayed by the satellite icon.

8. The method of claim 7 wherein the object relates to a product, the second user interface action taken on the satellite icon comprises a request for information about the product and the data responsive to the at least a second user interface action transmitted from the third computer to the second computer comprises the requested information.

9. The method of claim 8 wherein the object relates to a product, the second user interface action taken on the satellite icon comprises a request for information relating to the product and the data responsive to the at least a second user interface action transmitted from the third computer to the second computer comprises the requested information.

10. The method of claim 9 wherein the second user interface action taken on the satellite icon additionally comprises a request for periodic updates relating to the product and the data responsive to the at least a second user interface action is periodically transmitted from the third computer to the second computer comprises the requested information.

11. The method of claim 10 wherein the request for periodic updates relating to the product comprises a request for periodic updates relating to the product's price and the data transmitted from the third computer to the second computer comprise price updates.

12. The method of claim 11 wherein the price updates comprise promotions and sales.

13. The method of claim 1 wherein when the modified object is visibly displayed on the display device, the modified object is displayed with a label indicating that performing an interface action on the modified object will create a satellite icon.

14. The method of claim 1 wherein the object is a product and the modified object visibly displayed on the display device comprises an image of the product.

15. The method of claim 2 wherein the representation of data relating to the modified object transmitted by the third computer to the second computer is only displayed if a third user interface action is taken on the satellite icon.

16. The method of claim 15 wherein third user interface action is selected from the list: select, single click, double click, mouseover.

17. The method of claim 1 comprising the additional steps of
enabling the second computer to create a linking folder visibly displayed on a desktop of a graphical user interface displayed on the display device, wherein the linking folder is associated with at least one user;
enabling the second computer to copy the satellite icon to the linking folder;
enabling the third computer to receive data relating to the linking folder from the second computer using the communication channel.

18. The method of claim 17 wherein the data relating to the linking folder comprises data relating to every satellite icon contained in the linking folder.

19. The method of claim 17 wherein the linking folder is further associated with at least a second website available over the network comprising user information relating to the at least one user, and wherein the data relating to the linking folder comprises information which is sufficient to enable the third computer to retrieve the user information from the at least a second website.

20. The method of claim 19 wherein the at least a second website is a subscriber based website and the information which is sufficient to enable the third computer to retrieve the user information from the at least a second website comprises subscriber logon information.

21. The method of claim 20 wherein the at least a second website is a social networking site and the user information comprises user demographics.

22. The method of claim 1 wherein the first computer and the third computer are the same computer.

23. The method of claim 17 wherein the first computer and the third computer are the same computer.

24. A computer-readable medium having computer-executable instructions for a method comprising the steps of:
enabling a first computer to modify an object visibly displayed on a webpage, wherein the modified object is thereby enabled to be to be used to create a satellite icon,
enabling a second computer having a display device to create a satellite icon visibly displayed on a desktop of a graphical user interface displayed on the display device when,
the webpage is displayed on the display device, whereby the modified object is visibly displayed on the display device, and
a first user interface action is taken on the modified object visibly displayed on the display device;
causing a communication channel to be opened, over a network, between the second computer and a third computer when the satellite icon is created, whereby the third computer is enabled to send data to and receive data from the second computer.

25. The computer-readable medium of claim 24 additionally comprising the steps of:
enabling the second computer to display, using the satellite icon visibly displayed on the desktop of the graphical user interface, a representation of data relating to the modified object transmitted by the third computer to the second computer using the communication channel.

26. The computer-readable medium of claim 24 additionally comprising the steps of:
enabling the second computer to transmit from the second computer to the third computer, using the communication channel, data relating to at least a second user interface action taken on the satellite icon.

27. The computer-readable medium of claim 26 additionally comprising the steps of:
transmitting, over the network, data which is responsive to the at least a second user interface action from the third computer to the second computer.

28. The computer-readable medium of claim 24 wherein first user interface action is selected from the list: select, single click, double click, mouseover.

29. The computer readable medium of claim 24 wherein the at least a second first user interface action is selected from the list: select, single click, double click, mouseover, selection of a menu choice from a menu provided by the satellite icon, and typing text into a text entry field provided by the satellite icon.

30. The computer-readable medium of claim 25 wherein the object relates to a product and the data the transmitted by the third computer to the second computer using the communication channel relates to an advertisement for the product, whereby an advertisement for product is displayed by the satellite icon.

31. The computer-readable medium of claim 30 wherein the object relates to a product, the second user interface action taken on the satellite icon comprises a request for information about the product and the data responsive to the at least a second user interface action transmitted from the third computer to the second computer comprises the requested information.

32. The computer-readable medium of claim 31 wherein the object relates to a product, the second user interface action taken on the satellite icon comprises a request for information relating to the product and the data responsive to the at least a second user interface action transmitted from the third computer to the second computer comprises the requested information.

33. The computer-readable medium of claim 32 wherein the second user interface action taken on the satellite icon additionally comprises a request for periodic updates relating to the product and the data responsive to the at least a second user interface action is periodically transmitted from the third computer to the second computer comprises the requested information.

34. The computer-readable medium of claim 33 wherein the request for periodic updates relating to the product comprises a request for periodic updates relating to the product's price and the data transmitted from the third computer to the second computer comprise price updates.

35. The computer-readable medium of claim 34 wherein the price updates comprise promotions and sales.

36. The computer-readable medium of claim 24 wherein when the modified object is visibly displayed on the display device, the modified object is displayed with a label indicating that performing an interface action on the modified object will create a satellite icon.

37. The computer-readable medium of claim 24 wherein the object is a product and the modified object visibly displayed on the display device comprises an image of the product.

38. The computer-readable medium of claim 25 wherein the representation of data relating to the modified object transmitted by the third computer to the second computer is only displayed if a third user interface action is taken on the satellite icon.

39. The computer-readable medium of claim 38 wherein third user interface action is selected from the list: select, single click, double click, mouseover.

40. The computer-readable medium of claim 24 comprising the additional steps of:
enabling the second computer to create a linking folder visibly displayed on a desktop of a graphical user interface displayed on the display device, wherein the linking folder is associated with at least one user;
enabling the second computer to copy the satellite icon to the linking folder;
enabling the third computer to receive data relating to the linking folder from the second computer using the communication channel.

41. The computer-readable medium of claim 40 wherein the data relating to the linking folder comprises data relating to every satellite icon contained in the linking folder.

42. The computer-readable medium of claim 40 wherein the linking folder is further associated with at least a second website available over the network comprising user information relating to the at least one user, and wherein the data relating to the linking folder comprises information which is sufficient to enable the third computer to retrieve the user information from the at least a second website.

43. The computer-readable medium of claim 42 wherein the at least a second website is a subscriber based website and the information which is sufficient to enable the third computer to retrieve the user information from the at least a second website comprises subscriber logon information.

44. The computer-readable medium of claim 43 wherein the at least a second website is a social networking site and the user information comprises user demographics.

45. The computer-readable medium of claim 24 wherein the first computer and the third computer are the same computer.

46. The computer-readable medium of claim 40 wherein the first computer and the third computer are the same computer.

47. A system comprising:
a first computer configured to modify an object visibly displayed on a webpage, wherein the modified object is thereby configured to be to be used to create a satellite icon, whereby a second computer having a display device is configured to create a satellite icon visibly displayed on a desktop of a graphical user interface displayed on the display device when, the webpage is displayed on the display device, whereby the modified object is visibly displayed on the display device, and a first user interface action is taken on the modified object visibly displayed on the display device;
a third computer configured to communicate with the second computer using a communication channel opened, over a network, between the second computer and the third computer when the satellite icon is created, whereby the third computer is enabled to send data to and receive data from the second computer.

48. The system of claim 47 wherein:
the second computer is further enabled to display, using the satellite icon visibly displayed on the desktop of the graphical user interface, a representation of data relating to the modified object transmitted by the third computer to the second computer using the communication channel.

49. The system of claim 47 wherein:
the second computer is further enabled to transmit from the second computer to the third computer, using the communication channel, data relating to at least a second user interface action taken on the satellite icon.

50. The system of claim 49 wherein:
the third computer is further enabled to transmit, over the network, data which is responsive to the at least a second user interface action to the second computer.

51. The system of claim 50 wherein first user interface action is selected from the list: select, single click, double click, mouseover.

52. The system of claim 50 wherein the at least a second first user interface action is selected from the list: select, single click, double click, mouseover, selection of a menu choice from a menu provided by the satellite icon, and typing text into a text entry field provided by the satellite icon.

53. The system of claim 48 wherein the object relates to a product and the data the transmitted by the third computer to the second computer using the communication channel relates to an advertisement for the product, whereby an advertisement for product is displayed by the satellite icon.

54. The system of claim 53 wherein the object relates to a product, the second user interface action taken on the satellite icon comprises a request for information about the product and the data responsive to the at least a second user interface action transmitted from the third computer to the second computer comprises the requested information.

55. The system of claim 54 wherein the object relates to a product, the second user interface action taken on the satellite icon comprises a request for information relating to the product and the data responsive to the at least a second user interface action transmitted from the third computer to the second computer comprises the requested information.

56. The system of claim 55 wherein the second user interface action taken on the satellite icon additionally comprises a request for periodic updates relating to the product and the data responsive to the at least a second user interface action is periodically transmitted from the third computer to the second computer comprises the requested information.

57. The system of claim 56 wherein the request for periodic updates relating to the product comprises a request for periodic updates relating to the product's price and the data transmitted from the third computer to the second computer comprise price updates.

58. The system of claim 57 wherein the price updates comprise promotions and sales.

59. The system of claim 47 wherein when the modified object is visibly displayed on the display device, the modified object is displayed with a label indicating that performing an interface action on the modified object will create a satellite icon.

60. The system of claim 47 wherein the object is a product and the modified object visibly displayed on the display device comprises an image of the product.

61. The system of claim 48 wherein the second computer is further configured such that the representation of data relating to the modified object transmitted by the third computer to the second computer is only displayed if a third user interface action is taken on the satellite icon.

62. The system of claim 61 wherein third user interface action is selected from the list: select, single click, double click, mouseover.

63. The system of claim 47 comprising the additional steps of:
the second computer is further configured to create a linking folder visibly displayed on a desktop of a graphical user interface displayed on the display device, wherein the linking folder is associated with at least one user;
the second computer is further configured to enable the second computer to copy the satellite icon to the linking folder;
the third computer is further configured to receive data relating to the linking folder from the second computer using the communication channel.

64. The system of claim 63 wherein the data relating to the linking folder comprises data relating to every satellite icon contained in the linking folder.

65. The system of claim 63 wherein the linking folder is further associated with at least a second website available over the network comprising user information relating to the at least one user, and wherein the data relating to the linking folder comprises information which is sufficient to enable the third computer to retrieve the user information from the at least a second website.

66. The system of claim 65 wherein the at least a second website is a subscriber based website and the information which is sufficient to enable the third computer to retrieve the user information from the at least a second website comprises subscriber logon information.

67. The system of claim 66 wherein the at least a second website is a social networking site and the user information comprises user demographics.

68. The system of claim 47 wherein the first computer and the third computer are the same computer.

69. The system of claim 63 wherein the first computer and the third computer are the same computer.
